(19) United States
(12) Patent Application Publication
(10) Pub. No.: US 2023/0394282 A1
(43) Pub. Date: Dec. 7, 2023

(54) METHOD FOR TRAINING DEEP ENSEMBLE MODEL BASED ON FEATURE DIVERSIFIED LEARNING AGAINST ADVERSARIAL IMAGE EXAMPLES, IMAGE CLASSIFICATION METHOD AND ELECTRONIC DEVICE

(71) Applicant: DONGGUAN UNIVERSITY OF TECHNOLOGY, DONGGUAN (CN)

(72) Inventors: YI WANG, DONGGUAN (CN); BO HUANG, DONGGUAN (CN); ZHIWEI KE, DONGGUAN (CN)

(21) Appl. No.: 18/454,795

(22) Filed: Aug. 24, 2023

Related U.S. Application Data
(63) Continuation of application No. PCT/CN2021/077947, filed on Feb. 25, 2021.

(51) Int. Cl. G06N 3/045; G06N 3/094

(52) U.S. Cl. CPC G06N 3/045; G06N 3/094

(57) ABSTRACT

A method for training an ensemble model based on feature diversified learning includes: acquiring a high-level feature vector of each of the base networks by inputting example data into a current ensemble model; determining an activation intensity interval; acquiring an update of diversified features of the current ensemble model; outputting an output result corresponding to the example data based on the updated diversified features of the current ensemble model; and acquiring a target ensemble model by calculating a target loss function of the current ensemble model based on the example data and the output result, adjusting parameter values of the current ensemble model, and inputting the example data into the current ensemble model with the adjusted parameter values to continue training until the target loss function converges.

### CROSS-REFERENCE TO RELATED APPLICATIONS

This application is a continuation of International Application No. PCT/CN2021/077947, with an international filing date of Feb. 25, 2021, the entire contents of which are incorporated herein by reference.

### TECHNICAL FIELD

Embodiments of the present disclosure relate to the technical field of machine learning, and in particular, relate to a method for training an ensemble of deep neural network classifiers, namely (deep) ensemble model hereafter, against image adversarial examples, and an image classification method and an electronic device thereof.

### BACKGROUND

Deep learning classifiers are core to many real-world applications. With their prevalent usage and wide deployments, deep learning classifiers can be exposed in an adversarial environment and susceptible to intelligent attacks that can intentionally cause malfunction of those depending systems. In particular, deep learning classifiers are found to be susceptible to attacks by adversarial examples that add adversarial perturbation to the original image to intentionally cause misclassification errors. The amount of adversarial perturbation is often very small and imperceptible to human eyes in order to fool the classifiers. As such, adversarial example attacks have posed a serious threat to deep learning models and it is critical to develop countermeasure methods against adversarial examples.

Existing countermeasure methods are mostly designed for single classifier models to improve the model robustness against adversarial example, namely adversarial robustness hereafter. For instance, adversarial training of the classifier model is a typical countermeasure that mix normal examples with adversarial examples generated in each epoch of the training process. However, countermeasure methods deployed on a single classifier model often result in a difficult trade-off between the classification accuracy and adversarial robustness. In other words, such methods can improve the adversarial robustness but often at a cost of sacrificing the classification accuracy on normal examples. Moreover, existing methods tend to consume a large quantity of computer system resources. The gain of adversarial robustness can also diminish quickly when the training dataset has increased class labels or more complex data scenes.

### SUMMARY

To resolve the above issues of countermeasure against adversarial examples, a method for training a deep ensemble model based on feature diversified learning (which is a method for obtaining diversified features as described in the following steps, as proposed by the inventors of the present application), wherein the ensemble model is used for image classification against possible attacks by adversarial image examples, the ensemble model is an ensemble of K base networks, the method includes:
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model includes K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function includes an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model.

An image classification method is provided. The method includes:
acquiring an image to be classified;
inputting the image to be classified into a target ensemble model, wherein the target ensemble model is used for image classification against attacks by adversarial image examples, the target ensemble model is an ensemble deep neural network model, wherein the target ensemble model includes K base networks; and
outputting a classification result of the image to be classified;
wherein the target ensemble model is trained by the steps of:
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model includes K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function includes an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model.

An electronic device is provided. The electronic device includes: a processor, a memory, a communication interface, and a communication bus, wherein the processor, the memory, and the communication bus is capable of communicating with each other via the communication bus; and
the memory is configured to store at least one executable instruction, wherein the executable instruction, when loaded and executed, causes the processor to perform the steps of:
acquiring an image to be classified;
inputting the image to be classified into a target ensemble model, wherein the target ensemble model is used for image classification against attacks by adversarial image examples, the target ensemble model is an ensemble deep neural network model, wherein the target ensemble model includes K base networks; and
outputting a classification result of the image to be classified;
wherein the target ensemble model is trained by the steps of.
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model includes K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function includes an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model.

### BRIEF DESCRIPTION OF THE DRAWINGS

The accompanying drawings are merely for illustrating some exemplary embodiments, but shall not be construed as limiting the present disclosure. In all the accompanying drawings, like reference numerals denote like parts. In the drawings:

FIG. 1A is a schematic diagram of a standard neural network;

FIG. 1B is a schematic diagram of a neural network with Dropout;

FIG. 2 is a schematic flowchart of a method for training an ensemble model based on feature diversified learning according to an embodiment of the present disclosure;

FIG. 3 is a schematic diagram of comparison of resolutions in different training methods according to an embodiment of the present disclosure;

FIG. 4 is a schematic flowchart of an image classification method according to an embodiment of the present disclosure;

FIG. 5 is a schematic structural diagram of an apparatus for training an ensemble model based on feature diversified learning according to an embodiment of the present disclosure;

FIG. 6 is a schematic structural diagram of an image recognition apparatus according to an embodiment of the present disclosure; and

FIG. 7 is a schematic structural diagram of an electronic device according to an embodiment of the present disclosure.

### DETAILED DESCRIPTION

Some exemplary embodiments of the present disclosure are hereinafter described in detail with reference to the accompanying drawings. Although the accompanying drawings illustrate the exemplary embodiments of the present disclosure, it shall be understood that the present disclosure may be practiced in various manners, and the present disclosure shall not be limited by the embodiments illustrated herein.

First, technical terms in the embodiments of the present disclosure are interpreted.

Adaptive diversified promoting (ADP): is an output diversified learning method for an ensemble model.

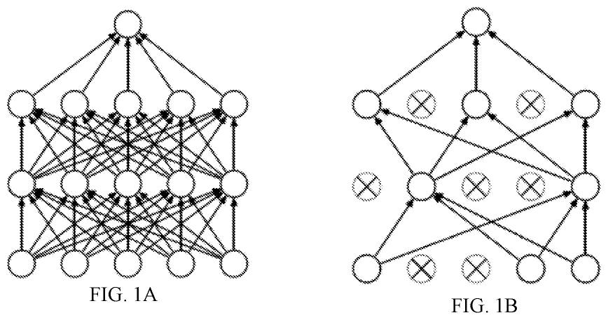

Dropout: is a neuron deactivation algorithm and an approach to be commonly used for training a deep neural network, which effectively prevents overfitting. As illustrated in FIG. 1A and FIG. 1B, FIG. 1A illustrates a conventional neural network structure not adopting Dropout, and FIG. 1B illustrates a neural network structure with Dropout.

Priority diversified dropouts (PDD): is a neuron deactivation algorithm based on priority diversification. In the embodiments of the present disclosure, in the ensemble model, all the K base networks are simultaneously trained. In each batch of iterative trainings, activation value intervals that are subject to prioritized retention for the base networks are assigned according to the number of activated neurons, such that activation intensities of the neurons in the K base networks are differentiated.

DEG is short for dispersed ensemble gradients, that is, ensemble gradients. In the embodiments of the present disclosure, the DEG is a penalty term for promoting maximization of loss gradient angles between the base networks in the ensemble model.

Discrimination Score serves as a measure for the degree of diversity in the ensemble model at the test phase, the diversity is the diversity of high-level image classification features extracted by each base network in the ensemble model.

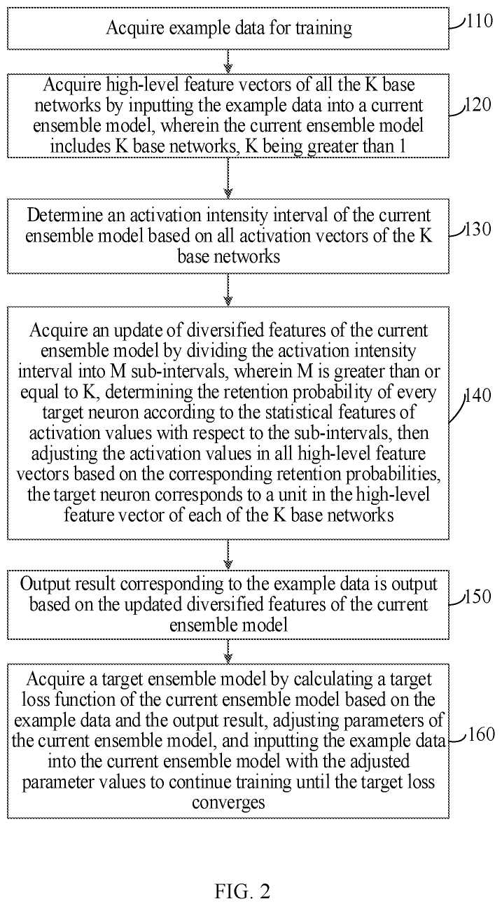

FIG. 2 is a schematic flowchart of a method for training an ensemble model based on feature diversified learning according to an embodiment of the present disclosure. The method is performed by an electronic device. The electronic device may be specifically a computer device or other terminal devices, such as a computer, a tablet computer, a mobile phone, a smart robot, or a wearable smart device. The ensemble model is designed to classify images subject to adversarial image example attacks, and the ensemble model is an ensembled deep neural network model. As illustrated in FIG. 2, the method includes the following steps.

In step 110, example data for training is acquired.

The example data is example data with an example label pre-annotated. With respect to the ensemble model for image classification, the sample data is normal sample image data with label, the label is a manual label for the image classification of the normal sample, and the normal sample is an original image sample that has not suffered adversarial perturbation attack.

In step 120, high-level feature vectors of all the K base networks are acquired by inputting the example data into a current ensemble model, wherein the current ensemble model includes K base networks, K being greater than 1.

The example data is input into the current ensemble model of the image classification subject to adversarial example attacks. The current ensemble model is an ensemble model formed of a plurality of base networks, and may be expressed by the following function:

$${\hat{y}}_{F} = \frac{1}{K} {\sum }_{k = 1}^{K} F ( x ; {θ}_{k} )$$

In the function, ŷ_{F} represents an output of the current ensemble model, for example, a prediction score; F(x; θₖ) represents a k^{th} base network; and y is a hot code of a true value label of x. In this embodiment, each current ensemble model being trained is an ensemble model that is acquired upon a previous training.

In this embodiment, in each training cycle, all training data in the example data is disordered and input, as well as the labels corresponding to the training data, into the current ensemble model. By forward propagation, a high-level feature vector and the output result of each base network are acquired. The output result is a prediction vector.

In step 130, an activation intensity interval of the current ensemble model is determined based on all activation vectors of the K base networks.

In this embodiment, high-level feature vectors of the base networks are acquired; the neuron activation values are statistically collected from all the high-level feature vectors and ranked in an ascending order of magnitudes, such that an interval [u, v] of activation intensity of the current ensemble model is determined, wherein u represents a minimum activation value, and v represents a maximum activation value. The activation intensity is measured by the activation value. The neuron activation value is the output of a neuron when taking an input of training examples to the model. In this embodiment, since each base network has different responses to the training input, their neuron activation values are different in the high-level feature vectors.

In step 140, an update of diversified features of the current ensemble model is acquired by dividing the activation intensity interval into M sub-intervals, wherein M is greater than or equal to K, determining the retention probability of every target neuron according to the statistical features of activation values with respect to the sub-intervals, then adjusting the activation values in all high−level feature vectors based on the corresponding retention probabilities, the target neuron corresponds to a unit in the high-level feature vector of each of the K base networks.

In this embodiment, the activation intensity interval is evenly partitioned into M sub-intervals, wherein the sub-intervals have an equal length. For example, with respect to an ensemble model having three base networks, the activation intensity interval is from 0.1 to 0.9, and this activation intensity interval is divided into four sub-intervals, namely, 0.1 to 0.3, 0.3 to 0.5, 0.5 to 0.7, and 0.7 to 0.9.

The statistical features of the activation values of the neurons in the sub-intervals may be numbers of the neurons in the sub-intervals, or may be expectations of all the activation values in the sub-intervals, or may be a total discrimination score of the activation values in the sub-intervals. The statistical features of the activation values of the neurons are not specifically limited, and may be correspondingly set by a person skilled in the art according to the specific scenario.

In one optional embodiment, the statistical features of the activation values of the neurons in the sub-intervals are numbers of neurons in the sub-intervals. Acquiring the updated diversified feature vector of the current ensemble model by determining retention probabilities of the neurons of the base models in the sub-intervals according to statistical features of the activation values of the neurons in the sub-intervals and adjusting the activation values of the neurons based on the retention probabilities includes the following sub-steps.

In sub-step 140, first K sub-intervals with a maximum number of neurons are determined, each as a priority interval. In this embodiment, upon even division of the activation intensity interval, the sub-intervals are ranked according to the numbers of neurons in the sub-intervals (that is, the numbers of activation values), such that first k sub-intervals in which the numbers of neurons are maximum are screened. Since the sub-intervals have an equal length range, the number of neurons in each interval only needs to be considered. Specifically, upon acquisition of the M sub-intervals, the M sub-intervals are ranked according to the numbers of neurons in the sub-intervals, such that the first K sub-intervals with a maximum number of activation values of the neurons are determined as priority intervals.

In this embodiment, one priority interval is assigned to each of the K base networks according to a predetermined assignment rule. A target priority interval is assigned to each target base network according to an assignment order prescribed in the assignment rule. For example, the highest priority interval (that is, with a maximum number of neurons) is assigned to one base network, and second highest priority interval is assigned to another base network, and so on so forth to assign priority intervals to subsequent base networks. In the following training process, the assignment of priority intervals is always based on this assignment rule. The target neurons are the neurons in a target base network, and the target base network is any of the base networks.

In sub-step 1402, the retention probabilities of the target neurons are determined according to whether the activation values of target neurons are within a target priority interval.

With respect to each of the K base networks, the retention probabilities of the target neurons are determined according to whether the activation values of the target neurons are within the target priority interval. In the case that the activation values of the target neurons are within the target priority interval, the target neurons are adjusted to have higher retention probabilities. In the case that the activation values of the target neurons are not within the target priority interval, the target neurons are adjusted to have lower retention probabilities. The target neurons are the neurons in a target base network, the target base network is any one single neural network classifier in the ensemble model, and the target priority interval is a priority interval assigned to the target base network; In this embodiment, the retention probabilities of the target neurons are adjusted using a retention probability adjustment formula: A predetermined formula for calculating the retention probability of a target neurons as follows:

$${p}_{m}^{k} = \{ \begin{matrix}α , & m = {t}_{k} \\ β \cdot ( 1 - \frac{{N}_{m}^{k}}{{C}^{k}} ) & m \neq {t}_{k}\end{matrix}$$

In the formula, pₘ^{k} represents an adjusted retention probability of a target neuron within an m^{th} sub-interval in a k^{th} target base network; tₖ represents a tₖ^{th} target priority interval assigned to the k^{th} target base network; m represents a sub-interval within which an activation value of the target neuron falls; Nₘ^{k} represents a number of neurons within an m^{th} sub-interval in the k^{th} target base network, which varies according to each training process and is a result of a previous training; C^{k} represents a total number of the neurons in the k^{th} target base network, which is a fixed value; α represents a first retention coefficient; β represents a second retention coefficient; and k ∈ K. in the formula, α and β are both hyper-parameters, α and β are coefficients between 0 and 1, α may be 0.9, and β may be 0.1. The total number of neurons in the k^{th} target base network refers to a total number of neurons on a target fully connected layer in the k^{th} target base network. The target fully connected layer refers to a fully connected layer where feature diversified learning functions in the k^{th} target base network, that is, a fully connected layer corresponding to the high-level feature vector where feature diversified learning functions.

To be specific, in the case that the target neurons in the k^{th} target base network are within a tₖ^{th} target priority interval assigned thereto, m=tₖ, and the retention probabilities of the target neurons are represented by pₘ^{k}=α; and in the case that the target neurons in the k^{th} target base network are not within the tₖ^{th} target priority interval assigned thereto, m≈tₖ, and the retention probabilities pₘ^{k} are represented by

$$β \cdot ( 1 - \frac{{N}_{m}^{k}}{{C}^{k}} ) .$$

In sub-step 1403, the activation values of the target neurons are adjusted based on the retention probabilities.

In the case that the retention probabilities of the target neurons are determined, each of the target neurons are sampled according to the 0-1 discrete type random variable distribution law, and single example values of activation random variables of the target neurons are randomly determined. In the case that a single example value is 1, the original activation value of the neuron is maintained; and in the case that a single example value is 0, the activation value of the neuron is reset to 0.

In one optional embodiment, the 0-1 distribution law is Bernoulli distribution, marked as Bernoulli(p), and a sampling formula thereof is:

P{X=x}=p^{x}(1−p)^{1-x}, x=0,1

To be specific, given the retention probability pⱼ^{k} and the original activation value zⱼ^{k} of the j^{th} neuron of the fully connected layer of the k^{th} target base network, the probability that the activation random variable X=1 of the neuron is P{X=1}=pⱼ^{k}; the probability of X=0 is P{X=0}=1−pⱼ^{kl}; and its adjusted activation value is \tilde{z}ⱼ^{k}=x*zⱼ^{k}, wherein x−Bernoulli(pⱼ^{k}).

In sub-step 1404, an update of diversified features of the current ensemble model is acquired based on the adjusted activation values of the target neurons.

In this case, the diversified features of the current ensemble model has been changed, whereas the current ensemble model has not been trained. Therefore, the parameter values of the current ensemble model have not been adjusted. In this way, the activation values of neurons base networks are distributed across the activation intervals, and the difference between the activation values of the neurons is increased, such that the diversity is increased.

In step 150, an output result corresponding to the example data is output based on the updated diversified features of the current ensemble model.

The example data is re-input into the current ensemble model, such that a data result corresponding to the example data is acquired. The output result includes a plurality of prediction vectors. It may be understood that the output result is a prediction result including image classification under attacks by adversarial image examples.

In step 160, a target ensemble model is acquired by calculating a target loss function of the current ensemble model based on the example data and the output result, adjusting parameters of the current ensemble model, and inputting the example data into the current ensemble model with the adjusted parameter values to continue training until the target loss converges.

In an optional embodiment, the base networks of the current ensemble model are simultaneously trained, and the target loss function is a sum of classification loss functions of all the base networks. The target loss is calculated for the current ensemble model using the conventional method for calculating the classification loss. When the target loss value is too large, the parameters of the current ensemble model are adjusted, and the current ensemble model is updated using the training method in step 110 to step 160, until the acquired loss converges. In this way, the target ensemble model is acquired.

In another optional embodiment, improvements may be made to the target loss function by adding a DEG loss to the ensemble classification loss for updating the current ensemble model. When the target loss value is too large, the parameters of the current ensemble model are adjusted, and the current ensemble model is updated using the training method in step 110 to step 160, until the acquired loss converges. In this way, the target ensemble model is acquired. Preferably, step S160 includes the following sub-steps.

In sub-step 1601, the ensemble classification loss is acquired by summing classification loss values from all base networks. In this embodiment, a classification loss from a base network is calculated based on the cross entropy loss between a prediction vector and the one-hot vector of an example label corresponding to an example in the example data.

In sub-step 1602, the DEG loss is calculated using a DEG loss formula based on pairwise gradients of the classification loss of each of the base networks with respect to the example data.

The DEG loss formula is:

$${ℒ}_{g} = {\sum }_{1 \leq i < j \leq K} \frac{< {g}_{i} , {g}_{i} >}{‖ {g}_{i} ‖ \cdot ‖ {g}_{j} ‖} .$$

In the formula, [symbol] _{g} represents a DEG loss to further increase the diversity of the ensemble model, wherein gᵢ represents a classification loss gradient of an i^{th} base network relative to the example data, and gⱼ represents a classification loss gradient of a j^{th} base network relative to the example data.

In this embodiment, a DEG loss formula is used for calculating the cosine of an included angle between the input gradients of any two of the K base networks in the ensemble.

In sub-step 1603, the target loss function is determined based on the total classification loss and the DEG loss.

The target loss function is:

Lₒᵤᵣₛ=L_{ECE}+λ·L_{g}

In this embodiment, X represents a hyperparameter for the penalty item of the DEG loss.

In sub-step 1604, the target ensemble model is acquired by adjusting the parameter values of the current ensemble model based on the target loss function and inputting the example data into the current ensemble model with the adjusted parameter values to continue training until the target loss function converges.

The gradient values of the classification loss and the DEG loss with respect to the model parameters are respectively solved by a back propagation algorithm, and then the gradient values are weighted and superposed according to the coefficient magnitude corresponding to each loss, and the model parameter is updated using the superposed gradient. In this way, the adjusted current ensemble model is acquired, and a model training is completed. In a next training, the current ensemble model upon parameter adjustment this time is determined as the current ensemble model, the data of the example data is input into the ensemble model in a random order, and the adjusted current ensemble model is trained in the same manner as above until the model almost converges. In this way, the target ensemble model is acquired.

In this way, the model training is incorporated with the PDD algorithm to acquire diversified features from each of the base networks, while in the calculation of the loss function, combined with a DEG loss, the diversity is further increased for the ensemble model, the diversity is the diversity of high-level image classification features extracted by each base network in the ensemble model.

According to this embodiment, in the simultaneous training process of the ensemble model, the activation values in high-level feature vectors are adjusted, such that the extracted features by each of the base networks are diversified and the adversarial robustness of the ensemble model is devised.

In this embodiment, the method further includes step 170: determining a degree of diversity of the high-level feature vector of each of the base networks in the target ensemble model based on the discrimination score. Step 170 specifically includes the following sub-steps.

In sub-step 1701, activation vectors of the K base networks in the target ensemble model are determined.

In sub-step 1702, mean values and variances of activation vectors of all K base networks are calculated, and a total discrimination score is calculated using a discrimination score formula.

The discrimination score formula is:

$${ℒ}_{f} = {\sum }_{1 \leq i < j \leq K} \frac{{( {μ}_{i} - {μ}_{j} )}^{2}}{{σ}_{i}^{2} + {σ}_{j}^{2}}$$

In the formula, [symbol] f represents a total discrimination score of the target ensemble model; μᵢ [symbol] represents a mean value of the activation vector of an i^{th} base network, μⱼ represents a mean value of the activation vector of a j^{th} base network; σᵢ represents a variance of the activation vector of an i^{th} base network; and σⱼ represents a variance of the activation vector of a j^{th} base network.

In this way, the degree of diversity of the base network can be effectively measured, the diversity is the diversity of high-level image classification features extracted by each base network in the ensemble model.

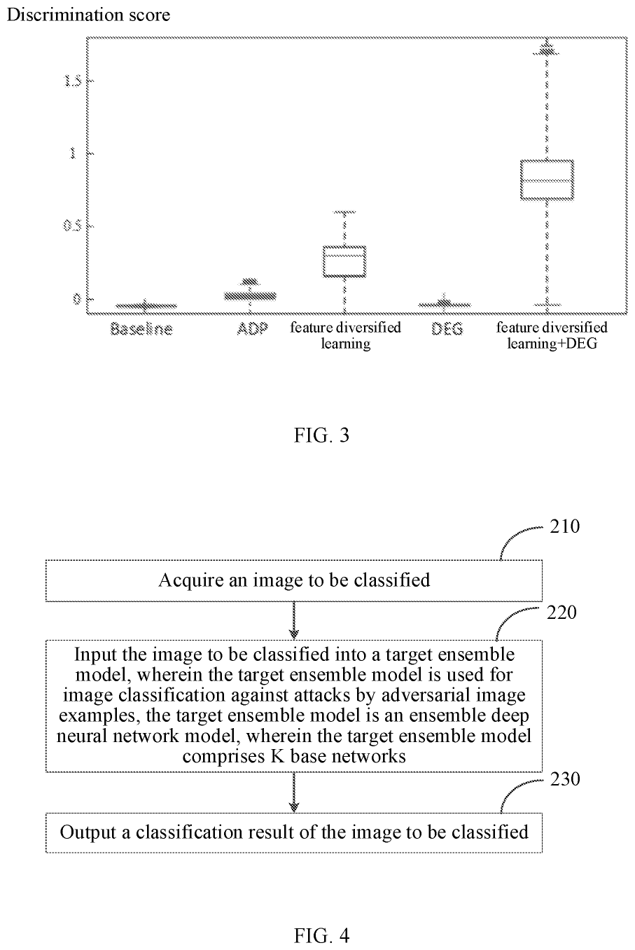

FIG. 3 illustrates the total discrimination scores acquired using the conventional approach, using feature diversified learning according to the embodiments of the present disclosure alone, using DEG according to the embodiments of the present disclosure alone, and using feature diversified learning+DEG according to the embodiments of the present disclosure. As can be seen from FIG. 3, the degree of diversity is significantly increased.

According to this embodiment, in the simultaneous training process of the ensemble model, the activation values in high-level feature vectors are adjusted, such that the extracted features by each of the base networks are diversified and the adversarial robustness of the ensemble model is devised.

Furthermore, by combining the differential processing of loss gradients, the adversarial robustness of the ensemble model is further improved while retaining the model classification accuracy on normal samples. In this way, the complex data sets are effectively processed and attacks from the adversarial samples are prevented.

FIG. 4 is a schematic flowchart of an image classification method according to an embodiment of the present disclosure. The method is performed by an electronic device. The electronic device may be a computer device. As illustrated in FIG. 4, the method includes the following steps.

In step 210, an image to be classified is acquired.

In step 220, the image to be classified is input into a target ensemble model, wherein the target ensemble model is used for image classification against attacks by adversarial image examples, the target ensemble model is an ensemble deep neural network model, wherein the target ensemble model includes K base networks.

In step 230, a classification result of the image to be classified is output.

Wherein the target ensemble model is trained by the method for training a deep ensemble model based on feature diversified learning as shown in FIG. 2.

According to this embodiment, in the simultaneous training process of the ensemble model, the activation values in high-level feature vectors are adjusted, such that the extracted features by each of the base networks are diversified and the adversarial robustness of the ensemble model is devised.

Furthermore, by combining the differential processing of loss gradients, the adversarial robustness of the ensemble model is further improved while retaining the model classification accuracy on normal samples. In this way, the complex data sets are effectively processed and attacks from the adversarial samples are prevented.

The image classification method according to the embodiment of the present disclosure effectively overcomes the problem of the adversarial samples, such that the image recognition result predicted by the model is more accurate.

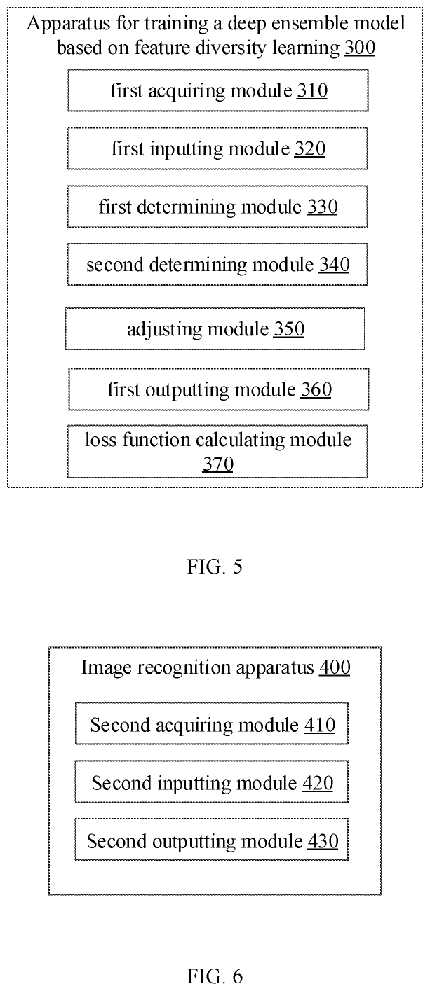

FIG. 5 is a schematic structural diagram of an apparatus for training an ensemble model based on feature diversified learning according to an embodiment of the present disclosure. As illustrated in FIG. 5, the apparatus 300 includes: a first acquiring module 310, a first inputting module 320, a first determining module 330, a second determining module 340, an adjusting module 350, a first outputting module 360, and a loss function calculating module 370.

The first acquiring module 310 is configured to acquire example data.

The first inputting module 320 is configured to acquire a high-level feature vector of each of the K base networks by inputting the example data into a current ensemble model, wherein the current ensemble model includes K base networks, K being greater than 1.

The determining module 330 is configured to determine an activation intensity interval of the current ensemble model based on the activation values in high-level feature vectors from the K base networks.

The adjusting module 340 is configured to acquire an update of diversified features of the current ensemble model by dividing the activation intensity interval into M sub-intervals, wherein M is greater than or equal to K, determining the retention probability of every target neuron according to the statistical features of activation values with respect to the sub-intervals, then adjusting the activation values in all high-level feature vectors based on the corresponding retention probabilities, the target neuron corresponds to a unit in the high-level feature vector of each of the K base networks.

The first outputting module 350 is configured to output an output result corresponding to the example data based on the updated diversified features of the current ensemble model; and

The loss function calculating module 360 is configured to acquire a target ensemble model by calculating a target loss function of the current ensemble model based on the example data and the output result, adjusting parameter values of the current ensemble model, and inputting the example data into the current ensemble model with the adjusted parameter values to continue training until the target loss function converges.

The specific operating processes of the apparatus for training the ensemble model based on feature diversified learning according to this embodiment are consistent with the steps of the specific method according to the above embodiment, which are not described herein any further.

According to this embodiment, in the simultaneous training process of the ensemble model, the activation values in the high-level feature vectors are adjusted, such that the extracted features of each of the base networks are diversified and the robustness of the ensemble model is devised.

Furthermore, by combining the differential processing of loss gradients, the adversarial robustness of the ensemble model is further improved while retaining the model classification accuracy on normal samples. In this way, the complex data sets are effectively processed and attacks from the adversarial samples are prevented.

FIG. 6 is a schematic structural diagram of an image recognition apparatus according to an embodiment of the present disclosure. As illustrated in FIG. 6, the apparatus 400 includes: a second acquiring module 410, a second inputting module 420, and a second outputting module 430.

The second acquiring module 410 is configured to acquire an image to be classified.

The second inputting module 420 is configured to input the image to be classified into a target ensemble model, wherein the target ensemble model includes K base networks, and the target ensemble model is trained by the method for training the ensemble model based on feature diversified learning as described above or the apparatus for training the ensemble model based on feature diversified learning.

The second outputting module 430 is configured to output a recognition result of the image to be classified.

The specific operating processes of the image recognition apparatus according to this embodiment are consistent with the steps of the specific method according to the above embodiment, which are not described herein any further.

According to this embodiment, in the simultaneous training process of the ensemble model, the activation values in high-level feature vectors are adjusted, such that the extracted features by each of the base networks are diversified and the adversarial robustness of the ensemble model is devised.

Furthermore, by combining the differential processing of loss gradients, the adversarial robustness of the ensemble model is further improved while retaining the model classification accuracy on normal samples. In this way, the complex data sets are effectively processed and attacks from the adversarial samples are prevented.

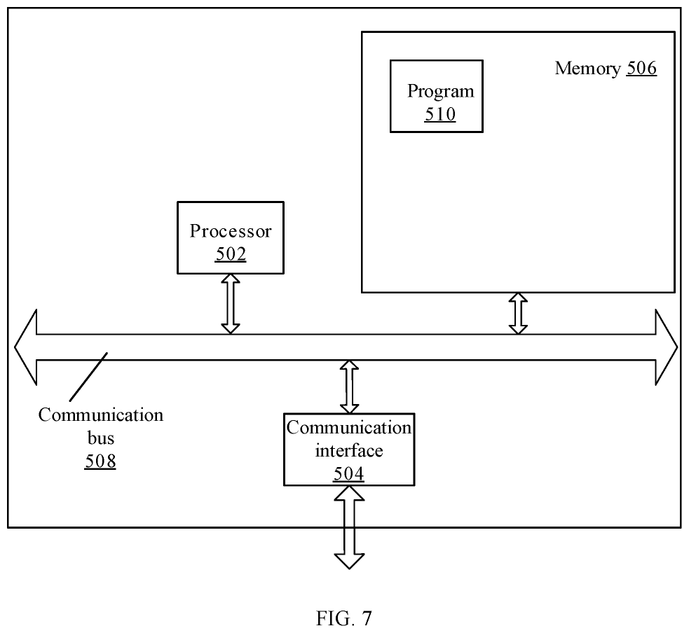

FIG. 7 is a schematic structural diagram of an electronic device according to an embodiment of the present disclosure. The specific implementation of the electronic device is not limited in the specific embodiments of the present disclosure.

As illustrated in FIG. 7, the electronic device may include: a processor 502, a communication interface 504, a memory 506, and a communication bus 508.

The processor 502, the communication interface 504, and the memory 506 communicate with each other via the communication bus 508. The communication interface 504 is configured to communicate with a network element of another device such as a client, a server or the like. The processor 502 is configured to run a program 510, and may specifically perform steps in the method for training the ensemble model based on feature diversified learning or the image classification method according to the above embodiments.

Specifically, the program 510 may include a program code, wherein the program code includes at least one computer-executable instruction.

The processor 502 may be a central processing unit (CPU) or an application specific integrated circuit (ASIC), or configured as one or more integrated circuits for implementing the embodiments of the present disclosure. The electronic device includes one or more processors, which may be the same type of processors, for example, one or more CPUs, or may be different types of processors, for example, one or more CPUs and one or more ASICs.

The memory 506 is configured to store the program 510. The memory 506 may include a high-speed RAM memory, or may also include a non-volatile memory, for example, at least one magnetic disk memory.

The program 510, when loaded and run by the processor 502, causes the electronic device to perform the following operations:
acquiring an image to be classified;
inputting the image to be classified into a target ensemble model, wherein the target ensemble model is used for image classification against attacks by adversarial image examples, the target ensemble model is an ensemble deep neural network model, wherein the target ensemble model includes K base networks; and
outputting a classification result of the image to be classified;
wherein the target ensemble model is trained by the steps of:
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model includes K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function includes an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model.

In one optional embodiment, wherein the statistical features of activation values with respect to the sub-intervals are the total number of activated neurons from all the base networks in the sub-intervals; and determining the retention probability of every target neuron includes:
determining first K sub-intervals with a maximum number of neurons, each as a priority interval, and determining, according to whether the activation values of target neurons are within a target priority interval, the retention probabilities of the target neurons;
adjusting the activation values of the target neurons based on the retention probabilities; and
acquiring diversified features based on the adjusted activation values of the target neurons;
wherein the target neurons corresponding to a high-level feature vector are neurons in the fully connected layer of a target base network, the target base network is any one single neural network classifier in the ensemble model, and the target priority interval is a priority interval assigned to the target base network.

In one optional embodiment, wherein determining, according to whether the activation values of target neurons are within a target priority interval, the retention probabilities of the target neurons includes:
adjusting the retention probabilities of the target neurons using a retention probability adjustment formula:
wherein the retention probability adjustment formula is:

$${p}_{m}^{k} = \{ \begin{matrix}α , & m = {t}_{k} \\ β \cdot ( 1 - \frac{{N}_{m}^{k}}{{C}^{k}} ) & m \neq {t}_{k}\end{matrix}$$

wherein in the formula, pₘ^{k} represents an adjusted retention probability of a target neuron within an m^{th} sub-interval in a k^{th} target base network; tₖ represents a tₖ^{th} target priority interval assigned to the k^{th} target base network; m represents a sub-interval within which an activation value of the target neuron falls; Nₘ^{k} represents a number of neurons within the m^{th} sub-interval in the k^{th} target base network; C^{k} represents a total number of the neurons in the k^{th} target base network; α represents a first retention coefficient; β represents a second retention coefficient; and k ∈ K.

In one optional embodiment, wherein acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges includes:
obtaining updated image classification prediction vector of each base network based on the example data and the output result of the diversified features after updating the current ensemble model, calculating a classification loss of each of the base networks using a predetermined loss function and the image classification loss of the ensemble model;
calculating a DEG loss using a DEG loss formula based on the classification loss gradients of the base networks with respect to the example data;
wherein the DEG loss formula is:

$${ℒ}_{g} = {Σ}_{1 \leq i < j \leq K} \frac{〈 {g}_{i} , {g}_{j} 〉}{‖ {g}_{i} ‖ \cdot ‖ {g}_{j} ‖} ;$$

wherein in the formula, [symbol] _{g} represents a DEG loss; i represents a serial number of an i^{th} base network; j represents a serial number of a j^{th} base network; gᵢ represents a gradient of the i^{th} base network relative to the example data; and gⱼ represents a gradient of a j^{th} base network relative to the example data;
determining the target loss function based on the image classification loss and the DEG loss; and
acquiring the target ensemble model by adjusting the parameter values of the current ensemble model based on the target loss function, and inputting the example data into the current ensemble model with the adjusted parameter values to continue training until the target loss function converges.

In one optional embodiment, wherein upon acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges, the method further measures diversity of the ensemble model; the method further includes:
determining activation vectors of the K base network in the target ensemble model; and
calculating mean values and variances of the activation vectors of all the K base networks, and calculating a total discrimination score using a discrimination score formula;
wherein the discrimination score formula is:

$${ℒ}_{f} = {\sum }_{1 \leq i < j \leq K} \frac{{( {μ}_{i} - {μ}_{j} )}^{2}}{{σ}_{i}^{2} + {σ}_{j}^{2}}$$

wherein in the formula, [symbol] _{f} represents a total discrimination score of the target ensemble model; μᵢ represents a mean value of the activation vector of an i^{th} base network, μⱼ represents a mean value of the activation vector of a j^{th} base network; σ₁ represents a variance of the activation vector of an i^{th} base network; and σⱼ represents a variance of the activation vector of a j^{th} base network.

The specific operating processes of the electronic device according to this embodiment are consistent with the steps of the specific method according to the above embodiment, which are not described herein any further.

According to this embodiment, in the simultaneous training process of the ensemble model, the activation values in high-level feature vectors are adjusted, such that the extracted features by each of the base networks are diversified and the adversarial robustness of the ensemble model is devised.

Furthermore, by combining the differential processing of loss gradients, the adversarial robustness of the ensemble model is further improved while retaining the model classification accuracy on normal samples. In this way, the complex data sets are effectively processed and attacks from the adversarial samples are prevented.

An embodiment of the present disclosure further provides a computer-readable storage medium. The computer-readable storage medium stores at least one executable instruction; wherein the at least one executable instruction, when loaded and executed by a processor of an electronic device, causes the electronic device to perform the operations corresponding to the method for training an ensemble model based on feature diversified learning or the image classification method according to any of the above embodiments.

The at least one executable instruction, when loaded and run by the processor of the electronic device, causes the electronic device to specifically perform the following operations:
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model includes K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function includes an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model; or
acquiring an image to be classified;
inputting the image to be classified into a target ensemble model, wherein the target ensemble model is used for image classification against attacks by adversarial image examples, the target ensemble model is an ensemble deep neural network model, wherein the target ensemble model includes K base networks; and
outputting a classification result of the image to be classified;
wherein the target ensemble model is trained by the steps of:
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model includes K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function includes an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model.

In one optional embodiment, wherein the statistical features of activation values with respect to the sub-intervals are the total number of activated neurons from all the base networks in the sub-intervals; and determining the retention probability of every target neuron includes:
determining first K sub-intervals with a maximum number of neurons, each as a priority interval, and determining, according to whether the activation values of target neurons are within a target priority interval, the retention probabilities of the target neurons;
adjusting the activation values of the target neurons based on the retention probabilities; and
acquiring diversified features based on the adjusted activation values of the target neurons;
wherein the target neurons corresponding to a high-level feature vector are neurons in the fully connected layer of a target base network, the target base network is any one single neural network classifier in the ensemble model, and the target priority interval is a priority interval assigned to the target base network.

In one optional embodiment, wherein determining, according to whether the activation values of target neurons are within a target priority interval, the retention probabilities of the target neurons includes:
adjusting the retention probabilities of the target neurons using a retention probability adjustment formula:
wherein the retention probability adjustment formula is:

$${p}_{m}^{k} = \{ \begin{matrix}α , & m = {t}_{k} \\ β \cdot ( 1 - \frac{{N}_{m}^{k}}{{C}^{k}} ) & m \neq {t}_{k}\end{matrix}$$

wherein in the formula, pₘ^{k} represents an adjusted retention probability of a target neuron within an m^{th} sub-interval in a k^{th} target base network; tₖ represents a tₖ^{th} target priority interval assigned to the k^{th} target base network; m represents a sub-interval within which an activation value of the target neuron falls; Nₘ^{k} represents a number of neurons within the m^{th} sub-interval in the k^{th} target base network; C^{k} represents a total number of the neurons in the k^{th} target base network; α represents a first retention coefficient; β represents a second retention coefficient; and k ∈ K.

In one optional embodiment, wherein acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges includes:
obtaining updated image classification prediction vector of each base network based on the example data and the output result of the diversified features after updating the current ensemble model, calculating a classification loss of each of the base networks using a predetermined loss function and the image classification loss of the ensemble model;
calculating a DEG loss using a DEG loss formula based on the classification loss gradients of the base networks with respect to the example data;
wherein the DEG loss formula is:

$${ℒ}_{g} = {Σ}_{1 \leq i < j \leq K} \frac{〈 {g}_{i} , {g}_{j} 〉}{‖ {g}_{i} ‖ \cdot ‖ {g}_{j} ‖} ;$$

wherein in the formula, [symbol] _{g} represents a DEG loss; i represents a serial number of an i^{th} base network; j represents a serial number of a j^{th} base network; gᵢ represents a gradient of the i^{th} base network relative to the example data; and gⱼ represents a gradient of a j^{th} base network relative to the example data;
determining the target loss function based on the image classification loss and the DEG loss; and
acquiring the target ensemble model by adjusting the parameter values of the current ensemble model based on the target loss function, and inputting the example data into the current ensemble model with the adjusted parameter values to continue training until the target loss function converges.

In one optional embodiment, wherein upon acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges, the method further measures diversity of the ensemble model; the method further includes:
determining activation vectors of the K base network in the target ensemble model; and
calculating mean values and variances of the activation vectors of all the K base networks, and calculating a total discrimination score using a discrimination score formula;
wherein the discrimination score formula is:

$${ℒ}_{f} = {\sum }_{1 \leq i < j \leq K} \frac{{( {μ}_{i} - {μ}_{j} )}^{2}}{{σ}_{i}^{2} + {σ}_{j}^{2}}$$

wherein in the formula, [symbol] _{f} represents a total discrimination score of the target ensemble model; μᵢ represents a mean value of the activation vector of an i^{th} base network, pₜ represents a mean value of the activation vector of a j^{th} base network; σᵢ represents a variance of the activation vector of an i^{th} base network; and σⱼ represents a variance of the activation vector of a j^{th} base network.

The specific operating processes of the computer-readable storage medium when running on the electronic device according to this embodiment are consistent with the steps of the specific method according to the above embodiment, which are not described herein any further.

According to this embodiment, in the simultaneous training process of the ensemble model, the activation values in high-level feature vectors are adjusted, such that the extracted features by each of the base networks are diversified and the adversarial robustness of the ensemble model is devised.

Furthermore, by combining the differential processing of loss gradients, the adversarial robustness of the ensemble model is further improved while retaining the model classification accuracy on normal samples. In this way, the complex data sets are effectively processed and attacks from the adversarial samples are prevented.

An embodiment of the present disclosure further provides an apparatus for training an ensemble model based on feature diversified learning. The apparatus is applicable to performing the method for training the ensemble model based on feature diversified learning according to any of the above embodiments.

An embodiment of the present disclosure further provides an image recognition apparatus. The apparatus is applicable to performing the above image classification method.

An embodiment of the present disclosure further provides a computer program. The computer program, when loaded and run by a processor of an electronic device, causes the electronic device to perform the method for training the ensemble model based on feature diversified learning or the image classification method according to any of the above embodiments.

An embodiment of the present disclosure provides a computer program product. The computer program product includes at least one computer program stored in a computer-readable storage medium. The at least one computer program includes at least one program instruction, which, when loaded executed by a computer, causes the computer to perform the method for training the ensemble model based on feature diversified learning according to any of the above embodiments.

The algorithms and displays provided herein are not inherently related to any specific computer, virtual system or other device. Various general-purpose systems may also be used with the teachings herein. According to the above description, the structure required for constructing such systems is obvious. In addition, the embodiments of the present disclosure are not directed to any specific programming language. It should be understood that the content of the present disclosure described herein may be carried out utilizing various programming languages, and that the above description for a specific language is for the sake of disclosing preferred embodiments of the present disclosure.

In the specification provided herein, a plenty of particular details are described. However, it may be understood that the embodiments of the present disclosure may also be practiced without these particular details. In some embodiments, well known methods, structures and technologies are not illustrated in detail for clear understanding of the specification.

Likewise, it shall be understood that, to streamline the present disclosure and facilitate understanding of one or more of various aspects of the present disclosure, in the above description of the exemplary embodiments of the present disclosure, various features of the embodiments of the present disclosure are sometimes incorporated in an individual embodiment, drawing or description thereof. However, the method according to the present disclosure shall not be explained to embody the following intention: the present disclosure for which protection is sought claims more features than those explicitly disclosed in each of the appended claims.

Those skilled in the art should understand that modules in the devices according to the embodiments may be adaptively modified and these modules may be configured in one or more devices different from the embodiments herein. Modules or units or components in the embodiments may be combined into a single module or unit or component, and additionally these modules, units or components may be practiced in a plurality of sub-modules, sub-units or sub-components. Besides that such features and/or processes or at least some of the units are mutually exclusive, all the features disclosed in this specification (including the appended claims, abstract and accompanying drawings) and all the processes or units in such disclosed methods or devices may be combined in any way. Unless otherwise stated, each of the features disclosed in this specification (including the appended claims, abstract and accompanying drawings) may be replaced by a provided same, equivalent or similar substitution.

It should be noted that the above embodiments illustrate rather than limit the present disclosure, and those skilled in the art may design alternative embodiments without departing from the scope of the appended claims. In the claims, any reference sign placed between the parentheses shall not be construed as a limitation to a claim. The word “comprise” or “include” does not exclude the presence of an element or a step not listed in a claim. The article “a” or “an” used before an element does not exclude the presence of a plurality of such elements. The present disclosure may be implemented by means of a hardware including several distinct elements and by means of a suitably programmed computer. In a unit claim enumerating several devices, several of the devices may be embodied by one and the same hardware item. Use of the words “first,” “second,” “third,” and the like does not mean any ordering. Such words may be construed as naming. The steps in the above embodiments, unless otherwise specified, shall not be understood as causing limitations to the execution order.

What is claimed is:

1. A method for training a deep ensemble model based on feature diversified learning, wherein the ensemble model is used for image classification against possible attacks by adversarial image examples, the ensemble model is an ensemble of K base networks, the method comprises:
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model comprises K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function comprises an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model.

2. The method according to claim 1, wherein the statistical features of activation values with respect to the sub-intervals are the total number of activated neurons from all the base networks in the sub-intervals; and determining the retention probability of every target neuron comprises:
determining first K sub-intervals with a maximum number of neurons, each as a priority interval, and determining, according to whether the activation values of target neurons are within a target priority interval, the retention probabilities of the target neurons;
adjusting the activation values of the target neurons based on the retention probabilities; and
acquiring diversified features based on the adjusted activation values of the target neurons;
wherein the target neurons corresponding to a high-level feature vector are neurons in the fully connected layer of a target base network, the target base network is any one single neural network classifier in the ensemble model, and the target priority interval is a priority interval assigned to the target base network.

3. The method according to claim 2, wherein determining, according to whether the activation values of target neurons are within a target priority interval, the retention probabilities of the target neurons comprises:
adjusting the retention probabilities of the target neurons using a retention probability adjustment formula:
wherein the retention probability adjustment formula is:
$${p}_{m}^{k} = \{ \begin{matrix}α , & m = {t}_{k} \\ β \cdot ( 1 - \frac{{N}_{m}^{k}}{{C}^{k}} ) & m \neq {t}_{k}\end{matrix}$$
wherein in the formula, pₘ^{k} represents an adjusted retention probability of a target neuron within an m^{th} sub-interval in a k^{th} target base network; tₖ represents a tₖ^{th} target priority interval assigned to the k^{th} target base network; m represents a sub-interval within which an activation value of the target neuron falls; N_{M}^{k} represents a number of neurons within the m^{th} sub-interval in the k^{th} target base network; C^{k} represents a total number of the neurons in the k^{th} target base network; α represents a first retention coefficient; β represents a second retention coefficient; and k ∈ K.

4. The method according to claim 1, wherein acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges comprises:
obtaining updated image classification prediction vector of each base network based on the example data and the output result of the diversified features after updating the current ensemble model, calculating a classification loss of each of the base networks using a predetermined loss function and the image classification loss of the ensemble model;
calculating a DEG loss using a DEG loss formula based on the classification loss gradients of the base networks with respect to the example data;
wherein the DEG loss formula is:
$${ℒ}_{g} = {Σ}_{1 \leq i < j \leq K} \frac{〈 {g}_{i} , {g}_{j} 〉}{‖ {g}_{i} ‖ \cdot ‖ {g}_{j} ‖} ;$$
wherein in the formula, [symbol] _{g} represents a DEG loss; i represents a serial number of an i^{th} base network; j represents a serial number of a j^{th} base network; gᵢ represents a gradient of the i^{th} base network relative to the example data; and gⱼ represents a gradient of a j^{th} base network relative to the example data;
determining the target loss function based on the image classification loss and the DEG loss; and
acquiring the target ensemble model by adjusting the parameter values of the current ensemble model based on the target loss function, and inputting the example data into the current ensemble model with the adjusted parameter values to continue training until the target loss function converges.

5. The method according to claim 1, wherein upon acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges, the method further measures diversity of the ensemble model; the method further comprises:
determining activation vectors of the K base network in the target ensemble model; and
calculating mean values and variances of the activation vectors of all the K base networks, and calculating a total discrimination score using a discrimination score formula;
wherein the discrimination score formula is:
$${ℒ}_{f} = {\sum }_{1 \leq i < j \leq K} \frac{{( {μ}_{i} - {μ}_{j} )}^{2}}{{σ}_{i}^{2} + {σ}_{j}^{2}}$$
wherein in the formula, [symbol] _{f} represents a total discrimination score of the target ensemble model; μᵢ represents a mean value of the activation vector of an i^{th} base network, μⱼ represents a mean value of the activation vector of a j^{th} base network; σ₁ represents a variance of the activation vector of an i^{th} base network; and σⱼ represents a variance of the activation vector of a j^{th} base network.

6. An image classification method, comprising:
acquiring an image to be classified;
inputting the image to be classified into a target ensemble model, wherein the target ensemble model is used for image classification against attacks by adversarial image examples, the target ensemble model is an ensemble deep neural network model, wherein the target ensemble model comprises K base networks; and
outputting a classification result of the image to be classified;
wherein the target ensemble model is trained by the steps of:
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model comprises K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function comprises an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model.

7. The method according to claim 6, wherein the statistical features of activation values with respect to the sub-intervals are the total number of activated neurons from all the base networks in the sub-intervals; and determining the retention probability of every target neuron comprises:
determining first K sub-intervals with a maximum number of neurons, each as a priority interval, and determining, according to whether the activation values of target neurons are within a target priority interval, the retention probabilities of the target neurons;
adjusting the activation values of the target neurons based on the retention probabilities; and
acquiring diversified features based on the adjusted activation values of the target neurons;
wherein the target neurons corresponding to a high-level feature vector are neurons in the fully connected layer of a target base network, the target base network is any one single neural network classifier in the ensemble model, and the target priority interval is a priority interval assigned to the target base network.

8. The method according to claim 7, wherein determining, according to whether the activation values of target neurons are within a target priority interval, the retention probabilities of the target neurons comprises:
adjusting the retention probabilities of the target neurons using a retention probability adjustment formula:
wherein the retention probability adjustment formula is:
$${p}_{m}^{k} = \{ \begin{matrix}α , & m = {t}_{k} \\ β \cdot ( 1 - \frac{{N}_{m}^{k}}{{C}^{k}} ) & m \neq {t}_{k}\end{matrix}$$
wherein in the formula, pₘ^{k} represents an adjusted retention probability of a target neuron within an m^{th} sub-interval in a k^{th} target base network; tₖ represents a tₖ^{th} target priority interval assigned to the k^{th} target base network; m represents a sub-interval within which an activation value of the target neuron falls; Nₘ^{k} represents a number of neurons within the m^{th} sub-interval in the k^{th} target base network; C^{k} represents a total number of the neurons in the k^{th} target base network; a represents a first retention coefficient; p represents a second retention coefficient; and k E K.

9. The method according to claim 6, wherein acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges comprises:
obtaining updated image classification prediction vector of each base network based on the example data and the output result of the diversified features after updating the current ensemble model, calculating a classification loss of each of the base networks using a predetermined loss function and the image classification loss of the ensemble model;
calculating a DEG loss using a DEG loss formula based on the classification loss gradients of the base networks with respect to the example data;
wherein the DEG loss formula is:
$${ℒ}_{g} = {Σ}_{1 \leq i < j \leq K} \frac{〈 {g}_{i} , {g}_{j} 〉}{‖ {g}_{i} ‖ \cdot ‖ {g}_{j} ‖} ;$$
wherein in the formula, [symbol] _{g} represents a DEG loss; i represents a serial number of an i^{th} base network; j represents a serial number of a j^{th} base network; gᵢ represents a gradient of the i^{th} base network relative to the example data; and gⱼ represents a gradient of a j^{th} base network relative to the example data;
determining the target loss function based on the image classification loss and the DEG loss; and
acquiring the target ensemble model by adjusting the parameter values of the current ensemble model based on the target loss function, and inputting the example data into the current ensemble model with the adjusted parameter values to continue training until the target loss function converges.

10. The method according to claim 6, wherein upon acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges, the method further measures diversity of the ensemble model; the method further comprises:
determining activation vectors of the K base network in the target ensemble model; and
calculating mean values and variances of the activation vectors of all the K base networks, and calculating a total discrimination score using a discrimination score formula;
wherein the discrimination score formula is:
$${ℒ}_{f} = {\sum }_{1 \leq i < j \leq K} \frac{{( {μ}_{i} - {μ}_{j} )}^{2}}{{σ}_{i}^{2} + {σ}_{j}^{2}}$$
wherein in the formula, [symbol] _{f} represents a total discrimination score of the target ensemble model; μᵢ represents a mean vae oTthe activation vector of an i^{th} base network, μⱼ represents a mean value of the activation vector of a j^{th} base network; σᵢ represents a variance of the activation vector of an i^{th} base network; and σⱼ represents a variance of the activation vector of a j^{th} base network.

11. An electronic device, comprising: a processor, a memory, a communication interface, and a communication bus, wherein the processor, the memory, and the communication bus are capable of communicating with each other via the communication bus; and
the memory is configured to store at least one executable instruction, wherein the executable instruction, when loaded and executed, causes the processor to perform the steps of:
acquiring an image to be classified;
inputting the image to be classified into a target ensemble model, wherein the target ensemble model is used for image classification against attacks by adversarial image examples, the target ensemble model is an ensemble deep neural network model, wherein the target ensemble model comprises K base networks; and
outputting a classification result of the image to be classified;
wherein the target ensemble model is trained by the steps of:
acquiring example data for training, wherein the example data is a normal sample from image data with label, the label is a manual label for image classification of the normal example, and the normal example is an original image sample without manipulation by adversarial perturbations;
acquiring a high-level feature vector of each of the K base networks by inputting the example data into a current ensemble model, wherein the current ensemble model comprises K base networks, K being greater than 1, the current ensemble model is used for protecting image classification against possible attacks by adversarial image examples, wherein the adversarial example has adversarial perturbations added to the normal example to intentionally cause misclassification errors;
determining an activation intensity interval of the current ensemble model based on activation values in all high-level feature vectors of the K base networks, wherein the high-level feature vector is a representation that contains all neuron activation values in the last fully connected layer of neural network from each base network;
acquiring an update of diversified high-level feature vectors, namely diversified features, of the current ensemble model by dividing the activation intensity interval into M sub-intervals, determining retention probabilities of the target neurons according to statistical features of the activation values in the sub-intervals, then adjusting the activation values in all high-level feature vectors based on the retention probabilities, wherein M is greater than or equal to K;
outputting a prediction result corresponding to the example data based on the updated diversified features of the current ensemble model; and
acquiring a target ensemble model by calculating a target loss function of the current ensemble model based on the example data and the output result, adjusting parameter values of the current ensemble model, and inputting the example data into the current ensemble model with the adjusted parameter values to continue training until the target loss converges, wherein the target loss function comprises an ensemble image classification loss and a DEG loss, the DEG loss is a penalty term to promote maximization of loss gradient angles between the base networks in the ensemble model, which helps to increase the diversity of the ensemble model, wherein the diversity is the diversity of high-level image classification features extracted by each base model.

12. The electronic device according to claim 11, wherein the statistical features of activation values with respect to the sub-intervals are the total number of activated neurons from all the base networks in the sub-intervals; and determining the retention probability of every target neuron comprises:
determining first K sub-intervals with a maximum number of neurons, each as a priority interval, and determining, according to whether the activation values of target neurons are within a target priority interval, the retention probabilities of the target neurons;
adjusting the activation values of the target neurons based on the retention probabilities; and
acquiring diversified features based on the adjusted activation values of the target neurons;
wherein the target neurons corresponding to a high-level feature vector are neurons in the fully connected layer of a target base network, the target base network is any one single neural network classifier in the ensemble model, and the target priority interval is a priority interval assignedto the target base network.

13. The electronic device according to claim 12, wherein determining, according to whether the activation values of target neurons are within a target priority interval, the retention probabilities of the target neurons comprises:
adjusting the retention probabilities of the target neurons using a retention probability adjustment formula:
wherein the retention probability adjustment formula is:
$${p}_{m}^{k} = \{ \begin{matrix}α , & m = {t}_{k} \\ β \cdot ( 1 - \frac{{N}_{m}^{k}}{{C}^{k}} ) & m \neq {t}_{k}\end{matrix}$$
wherein in the formula, pₘ^{k} represents an adjusted retention probability of a target neuron within an m^{th} sub-interval in a k^{th} target base network; tₖ represents a tₖ^{th} target priority interval assigned to the k^{th} target base network; m represents a sub-interval within which an activation value of the target neuron falls; N_{M}^{k} represents a number of neurons within the m^{th} sub-interval in the k^{th} target base network; C^{k} represents a total number of the neurons in the k^{th} target base network; α represents a first retention coefficient; β represents a second retention coefficient; and k ∈ K.

14. The electronic device according to claim 11, wherein acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges comprises:
obtaining updated image classification prediction vector of each base network based on the example data and the output result of the diversified features after updating the current ensemble model, calculating a classification loss of each of the base networks using a predetermined loss function and the image classification loss of the ensemble model;
calculating a DEG loss using a DEG loss formula based on the classification loss gradients of the base networks with respect to the example data;
wherein the DEG loss formula is:
$${ℒ}_{g} = {Σ}_{1 \leq i < j \leq K} \frac{〈 {g}_{i} , {g}_{j} 〉}{‖ {g}_{i} ‖ \cdot ‖ {g}_{j} ‖} ;$$
wherein in the formula, [symbol] _{g} represents a DEG loss; i represents a serial number of an i^{th} base network; j represents a serial number of a j^{th} base network; gᵢ represents a gradient of the i^{th} base network relative to the example data; and gⱼ represents a gradient of a j^{th} base network relative to the example data;
determining the target loss function based on the image classification loss and the DEG loss; and
acquiring the target ensemble model by adjusting the parameter values of the current ensemble model based on the target loss function, and inputting the example data into the current ensemble model with the adjusted parameter values to continue training until the target loss function converges.

15. The electronic device according to claim 11, wherein upon acquiring the target ensemble model by calculating the target loss function of the current ensemble model based on the example data and the output result, adjusting the parameter values of the current ensemble model, and inputting the example data into the current ensemble model with the adjusted parameter values to continue training until the target loss function converges, the method further measures diversity of the ensemble model; the method further comprises:
determining activation vectors of the K base network in the target ensemble model; and
calculating mean values and variances of the activation vectors of all the K base networks, and calculating a total discrimination score using a discrimination score formula;
wherein the discrimination score formula is:
$${ℒ}_{f} = {\sum }_{1 \leq i < j \leq K} \frac{{( {μ}_{i} - {μ}_{j} )}^{2}}{{σ}_{i}^{2} + {σ}_{j}^{2}}$$
wherein in the formula, [symbol] _{f} represents a total discrimination score of the target ensemble model; μᵢ represents a mean value of the activation vector of an i^{th} base network, μⱼ represents a mean value of the activation vector of a j^{th} base network; σᵢ represents a variance of the activation vector of an i^{th} base network; and σⱼ represents a variance of the activation vector of a j^{th} base network.
